(19) United States
(12) Patent Application Publication
(10) Pub. No.: US 2014/0369746 A1
(43) Pub. Date: Dec. 18, 2014

(54) MOUNTING DEVICE FOR MOUNTING NARROW MACHINE ELEMENTS ON A SHAFT

(71) Applicant: Fenner U.S., Inc., Manheim, PA (US)

(72) Inventors: Stephen F. Heston, East Petersburg, PA (US); Eric S. Mosser, Palmyra, PA (US)

(21) Appl. No.: 14/304,928

(22) Filed: Jun. 14, 2014

Related U.S. Application Data
(60) Provisional application No. 61/836,497, filed on Jun. 18, 2013.

(51) Int. Cl. F16D 1/08

(52) U.S. Cl. CPC F16D 1/0829
USPC 403/374.4

(57) ABSTRACT

A mounting device for coupling two rotatable elements is provided. Specifically, a device for mounting a machine element onto a shaft, and in particular for mounting a narrow machine element on to a shaft, is provided. In one embodiment, the device includes a radially deformable inner sleeve that cooperates with an outer sleeve. A locking nut threads onto the inner sleeve to displace a thrust plate toward the outer sleeve so that the machine element is clamped between the thrust plate and the outer sleeve. In another embodiment, the device includes opposing pairs of inner and outer sleeves having mating tapered surfaces to provide axial clamping force and radial clamping force. The machine element is axially clamped between the pairs of inner and outer sleeves.

### PRIORITY CLAIM

This application claims priority to U.S. Provisional application No. 61/836,497 filed Jun. 18, 2013. The entire disclosure of the foregoing application is hereby incorporated herein by reference.

### FIELD OF THE INVENTION

The present invention relates to the field of mounting devices. Specifically, the present invention relates to the field of coupling two rotatable elements. In particular, the invention relates to mounting a machine element onto a shaft.

### BACKGROUND

The use of devices for mounting machine elements, such as pulleys and gears, upon a shaft is well-known. One such device is disclosed in U.S. Pat. No. 5,695,297 of Geib. Although the mounting devices disclosed in Geib U.S. Pat. No. 5,695,297 have been commercially successful, there exist applications in which the known devices have limitations. For instance, if a machine element is narrow, the interface between the bore of the machine element and the mounting element may limit the amount of torque, thrust or other such forces that can be transmitted between a shaft and the machine element. Accordingly, there continues to be a need for improved mounting devices to address various applications, such as mounting narrow machine elements.

### SUMMARY OF THE INVENTION

In light of the shortcomings of the prior art, the present invention provides an improved system for coupling rotatable elements. For example, the present invention provides an improved system for mounting a machine element onto a drive element, such as a sprocket onto a shaft. In particular, the present invention provides an improved system for mounting machine elements in which the diameter of the machine element is substantially greater than the diameter of the drive element, such as the shaft. Additionally, the present invention provides an improved system for mounting machine elements in which the axial length of the machine element is substantially smaller than the diameter of the drive element, such as the shaft. Additionally, the present invention provides an improved system for mounting machine elements in which the machine element is formed of a material that may not support the hoop stress generated by mounting elements that expand radially outwardly against the bore of the machine element.

### DESCRIPTION OF THE DRAWINGS

The foregoing summary and the following detailed description of the preferred embodiments of the present invention will be best understood when read in conjunction with the appended drawings, in which:

FIG. 1 is a sectional view of a mounting device for coupling two rotatable elements.

FIG. 2 is a sectional view of the device illustrated in FIG. 1 in a tightened position.

FIG. 3 is an exploded perspective view of the device illustrated in FIG. 1.

FIG. 4 is a side sectional view of a mounting device for coupling two rotatable elements.

FIG. 5 is an end view of a mounting device for coupling two rotatable elements.

FIG. 6 is a sectional view of the mounting device illustrated in FIG. 5 taken along line 6-6.

FIG. 7 is a sectional view of the mounting device illustrated in FIG. 6 in combination with a shaft and a machine element.

FIG. 8 is an end view of a mounting device for coupling a plurality of machine elements to a shaft.

FIG. 9 is a sectional view of the mounting device illustrated in FIG. 8 taken along line 9-9.

FIG. 10 is a sectional view of a mounting device for coupling two rotatable elements.

FIG. 11A is a fragmentary sectional view of the mounting device illustrated in FIG. 10 illustrating a step in unlocking the device.

FIG. 11 B is a fragmentary sectional view of the mounting device illustrated in FIG. 10 illustrating a second step in unlocking the device.

FIG. 12 is a sectional view of a mounting device for coupling two rotatable elements.

FIG. 13 is a sectional view of a mounting device for coupling two rotatable elements.

### DETAILED DESCRIPTION OF THE INVENTION

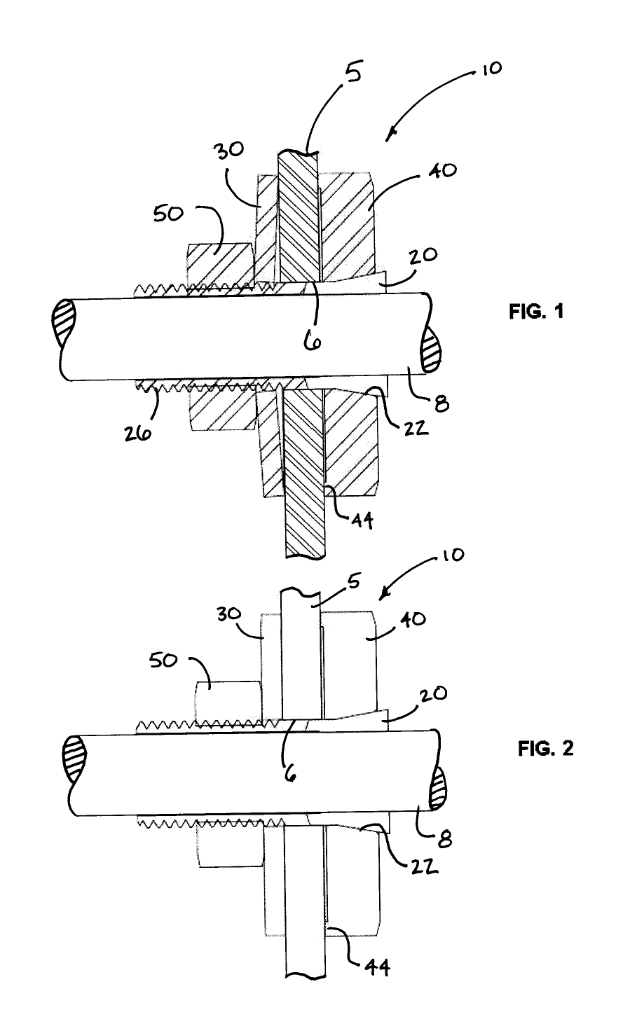

Referring now to the figures in general and to FIGS. 1-4 specifically, a mounting device is designated generally 10. The mounting device 10 is operable to couple two rotatable elements so that the two elements rotate together. For instance, the mounting device is operable to couple a machine element 5 with a rotary drive element, such as a shaft 8. The device 10 comprises elements that cooperate to apply a radial clamping force to the drive shaft to couple the mounting device to the shaft. The device also comprises elements that cooperate to apply an axial clamping force to the machine element to couple the machine element to the shaft. In this way, the device 10 provides a coupling between two rotatable elements in applications in which applying a radial clamping force to the outer rotatable element may be ineffective or inappropriate.

The mounting device comprises an inner sleeve 20, an outer sleeve 40, and axial clamping element 30 and a locking nut 50. The inner sleeve 20 is tubular in form having an internal bore that cooperates with the external surface of the shaft 8. Specifically, if the external surface of the shaft is tapered or frustoconical, the internal surface of the inner sleeve has a cooperating tapered or frustoconical surface. In the present instance, the shaft is cylindrical, and the inner sleeve 20 has a cylindrical bore with a diameter that corresponds to the diameter of the shaft. Preferably, the bore of the inner sleeve is slightly greater in diameter than the shaft 8 to permit free sliding movement of the inner sleeve 20 on the shaft 8 both axially and circumferentially.

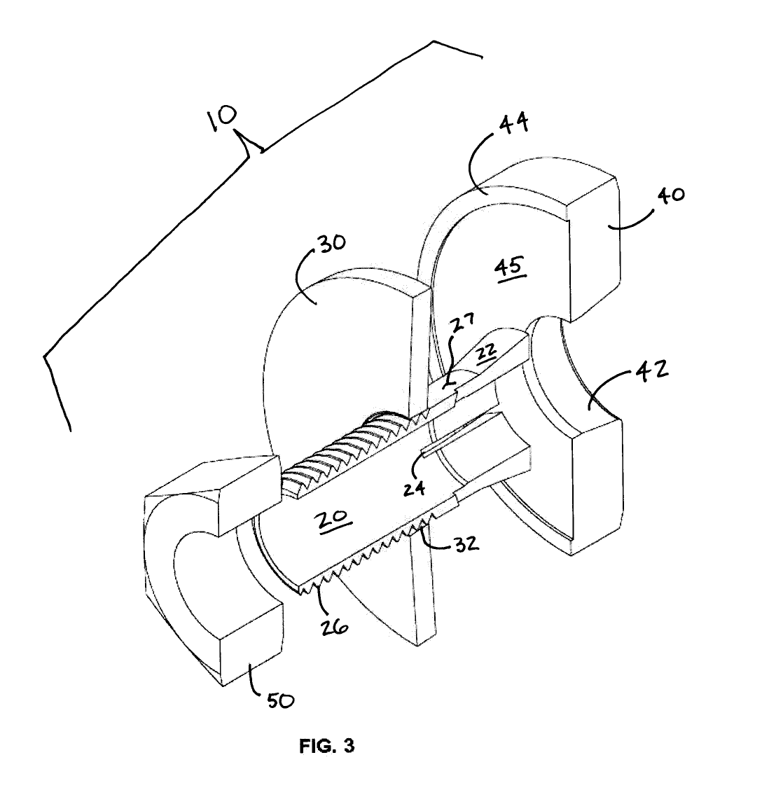

As discussed further below, the inner sleeve 20 engages the shaft 8 by contracting so that the inner sleeve grips or clamps down onto the shaft. For this purpose, the inner sleeve 20 is formed into a plurality of segments by slots 24 that extend longitudinally through the sleeve from the forward end. The slots 24 allow radial deflection of the inner sleeve as the mounting device is tightened or released. Preferably, the slots terminate along a line spaced inwardly from the forward end of the inner sleeve 20. In this way, the rearward portion of the inner sleeve 20 is an unsplit solid continuous ring portion. In the present instance, the inner sleeve is made from steel and provided with six equally spaced slots. It will be recognized, however, that the number of slots, as well as the width, length and spacing of the slots can be varied to achieve the desired flexibility. Additionally, as shown in FIG. 3, the interior bore of the inner sleeve 20 may be counterbored so that the inner diameter of the sleeve rearward of the tapered section (i.e. the threaded portion and the cylindrical portion) is slightly larger than the inner diameter at the tapered section. In this way, since the non-split portion of the inner sleeve is generally rigid, the larger internal diameter allows the sleeve to slide more easily over any imperfections on the shaft. Additionally, since the radial clamping force is concentrated in the area below the tapered portion 22, the additional clearance provided by the counterbore has minimal or no impact on the clamping force between the inner sleeve and the shaft.

The inner sleeve 20 is adapted to fit within the outer sleeve 40, which is a solid sleeve without slots. In the present instance, the outer sleeve 40 comprises a solid disk or collar having a tapered bore 42. The tapered bore 42 is configured to mate with the frustoconical external surface 22 of the inner sleeve. In particular, in the present instance, the tapered bore has an internal taper substantially similar to the external taper of the inner sleeve 20. In the present instance, the outer sleeve also comprises a circumferential flange 44 projecting axially away from the rearward face of the outer sleeve 30. The flange is spaced from the inner bore 42 of the outer sleeve. In this way, a recess or relieved portion 45 is formed between the bore 42 and the circumferential flange. As discussed further below, the recess ensures that the outer sleeve 40 engages the machine element 5 at a point spaced radially outwardly from the bore of the outer sleeve.

The mounting device 10 further includes a thrust plate 30 for transmitting an axial force onto the machine element to provide an axial clamping force between the device and the machine element. The thrust plate 30 may be a generally cylindrical collar configured similar to the outer sleeve 40 with a cylindrical bore. However, in the present instance, the thrust plate 30 is concave relative to the machine element 5. In this way, the outer circumference of the thrust plate 30 engages the machine element 5 while the central portion of the thrust plate is spaced apart from the thrust plate as shown in FIG. 1.

Referring again to FIGS. 1-2, the mounting device includes a threaded nut 50 for tightening and loosening the device. The diameter of the nut is preferably substantially smaller than the diameter of the thrust plate. The nut 50 comprises internal threads that cooperate with the external threads 26 of the inner sleeve 20 to tighten the device.

Configured as described above, the device 10 operates as follows. The inner sleeve 20 is mounted onto a rotatable element, such as a shaft 8. The outer sleeve 40 is mounted over the shaft and the inner sleeve 20 so that the bore 42 of the outer sleeve nests with the frustoconical surface 22 of the inner sleeve. The machine element 5 is placed over the shaft and the inner sleeve so that the inner bore of the machine element overlies the inner sleeve between the frustoconical portion 22 and the threaded portion 26. In particular, in the present instance, the inner sleeve comprises a cylindrical portion 27 rearward of the frustoconical portion 22. The cylindrical portion 27 has an outer diameter configured to substantially match the internal bore 6 of the machine element. In this way, the cylindrical portion operates as an alignment element to radially align the machine element with the inner sleeve to minimize radial runout. Accordingly, the cylindrical portion 27 aligns the machine element substantially perpendicular to the axis of the shaft and impedes canting of the machine element relative to the axis of the shaft.

The thrust plate 30 is mounted onto the shaft over the inner sleeve 20 so that the machine element is sandwiched between the thrust plate and the outer sleeve 40. The nut is then threaded onto the inner sleeve 20 and as shown in FIG. 1, the outer rim of the thrust plate 30 engages the machine element 5 and the circumferential flange 44 engages the machine element. Prior to tightening the device, the device and the machine element may be moved along the axial length of the shaft or rotated around the shaft to position the machine element at the appropriate axial and radial position.

To tighten the device 10, the nut 50 is rotated relative to the inner sleeve 20 in a first direction. Rotating the nut displaces the inner sleeve 20 axially relative to the outer sleeve 40. The relative axially displacement causes the tapered surface 23 of the inner sleeve to ride up the tapered surface of the bore 42 of the outer sleeve 40, thereby causing a wedging force that deflects the inner sleeve radially and creates a radial clamping force that clamps the inner sleeve inwardly against the shaft and outwardly against the outer sleeve.

At the same time, turning the nut in the first direction drives the nut against the thrust plate 30 which creates an axial clamping force between the outer rim of the thrust plate and the machine element on one side and between the circumferential flange 44 of the outer sleeve 40 and the machine element on the other side. Accordingly, rotating the nut 50 to tighten the device operates to create radial clamping force between the device and the shaft and axial clamping forces between the device and the machine element.

Although the thrust plate 30 may be a generally rigid element as described above, in the present instance, the thrust plate is flexible. In particular, the thrust plate may be axially and/or radially flexible. Furthermore, the thrust plate 30 may provide an axial biasing force between the machine element 5 and the nut 50. For instance, the thrust plate may be a frustoconically shaped axially deformable element. By way of example, in the present instance, the thrust plate 30 is a Belleville washer. In addition to providing an axial biasing force between the machine element and the nut, the thrust plate may provide an indicator of whether sufficient torque has been applied to the nut to tighten the device. Specifically, the Belleville washer is configured so that when the appropriate tightening torque is applied to the nut, the Belleville washer is flattened up against the machine element as shown in FIG. 2. Using an elastically deformable thrust plate, such as a Belleville washer, may also provide further benefits. For instance, the bias from the deflected Belleville washer will tend to impede loosening of the device due to creep, temperature variations, vibrations and other factors that can cause the connection to relax or loosen.

As described above, the device is tightened by rotating the lock nut 50 in a first direction. The device may be loosened by rotating the lock nut in a second direction that is the reverse of the second direction. Depending on the configuration of the locking tapers and the materials from which the various components are formed, when the lock nut is rotated in the second direction to loosen the device, some or all of the elements may loosen. Specifically, as shown in FIG. 1, the taper angle is such that the cooperating tapers may be self-locking depending on the materials from which the inner and outer sleeves 20, 30 are formed. A material such as stainless steel may have a high enough coefficient of friction that even if the lock nut is loosened, the tapers will remain locked. In certain applications, this may be beneficial. For instance, if the machine element is a saw blade or similar cutting element, the lock nut 50 may be loosened and removed along with the Belleville washer 30 and the saw blade 5. However, if the inner and outer sleeves are self-locking, the sleeves will remain locked on the shaft 8. Therefore, a new saw blade can be mounted onto the shaft after the old one is removed and the location of the saw blade will remain constant because the sleeves 20, 40 remained locked onto the shaft 8.

In other applications, the sleeves 20, 40 may be formed such that the cooperating tapered surfaces 22, 42 are self-releasing. In such an embodiment, the sleeves automatically loosen when the lock nut 50 is loosened. If the tapers are self-releasing, the entire device 10 is loosened when the lock nut is loosened. On the other hand, if the tapers are self-locking, an additional axial force is applied to drive the inner ring axially relative to the outer ring to release the locked tapers after the lock nut is loosened. For instance, an axial force may be applied directly to one of the sleeves by a tool such as a hammer or gear puller.

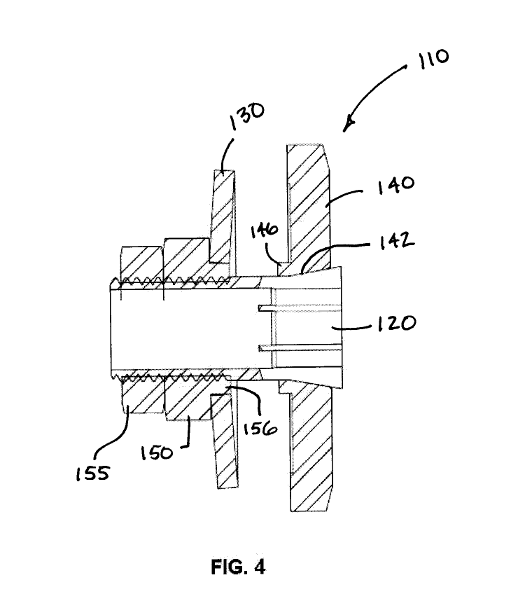

Referring now to FIG. 4, a variation of the mounting device illustrated in FIGS. 1-3 is designated generally 110. The mounting device 110 illustrates several optional features that may be incorporated into the mounting device. For instance, the device 110 may have an alignment element formed on the outer sleeve 140 rather than on the inner sleeve. Specifically, in FIG. 4, the outer sleeve comprises a flange 146 projecting axially away from the inner face of the outer sleeve. The flange 146 extends around the minor diameter of the tapered bore 142 of the outer sleeve. The flange forms a cylindrical surface that mates with the inner bore of the machine element to align the machine element perpendicularly and/or radially with the mounting device and the shaft.

Similarly, the locking nut 150 may also include a flange 156 projecting axially away from the inner face around the bore of the nut. The flange 156 forms a cylindrical surface that mates with the inner bore of the thrust plate 130 to align the thrust plate perpendicularly and/or radially with the mounting device and the shaft. Further still, the device may include a second nut 155 that operates as a jam nut to impede the locking nut 150 from loosening during operation. Specifically, after tightening the locking nut until the Belleville washer 130 is flattened, the second nut 155 is tightened up against the locking nut. In the present instance, the outer sleeve 140 may include an outer surface configured to aid in the tightening process. Specifically, the outer sleeve may have opposing flat surfaces that provide surfaces for engaging a wrench. Similarly, the outer surface of the outer sleeve may form a polygonal shape, such as a hex shape similar to the lock nuts 150, 155.

Additionally, as noted above, although the thrust plate has been illustrated in FIGS. 1-4 and described as a flexible element, such as a Belleville washer, as described above, the thrust plate may be a substantially rigid plate. It should also be noted that any or all of the alternative features shown in FIG. 4 and described above can be incorporated into the device shown in FIGS. 1-3 and described above.

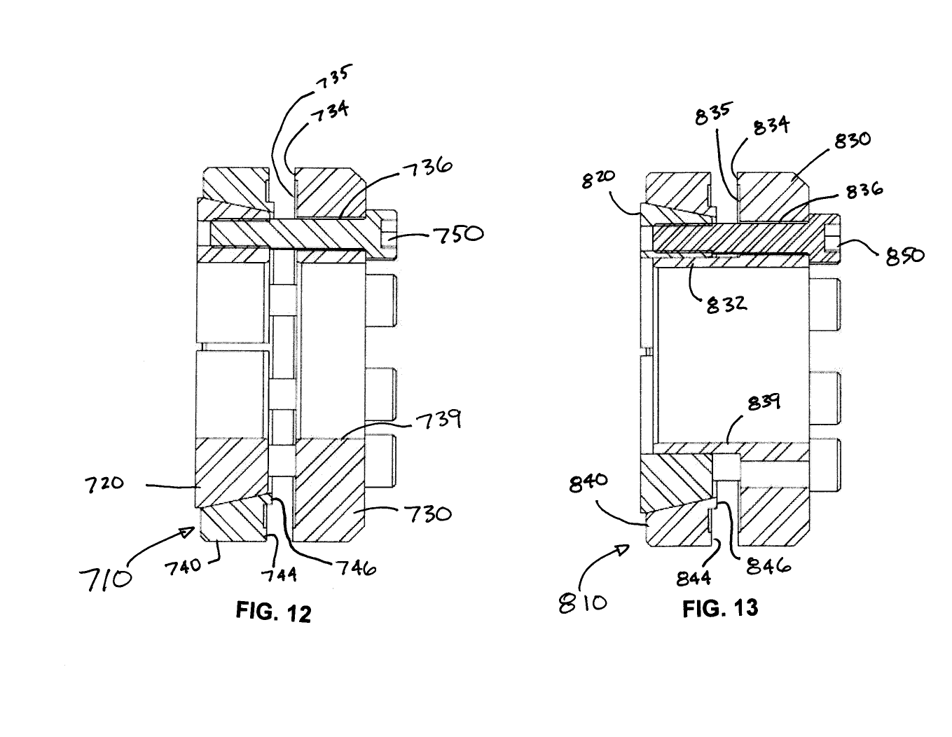

Referring now to FIG. 12 a device for coupling two rotatable elements is designated generally 710. Rather than having a central locking nut as described above, the mounting device 710 utilizes a plurality of locking screws 750 spaced around the device to tighten and release the device. The locking screws extend between the thrust plate 730 and the inner ring 720 and operate to tighten and release the inner and outer ring. The components of the mounting device may be formed of any of a variety of materials that are generally rigid, however, in the present instance the components are formed of metal, such as steel.

The inner ring 720 functions substantially similarly to the inner ring 20 illustrated in FIGS. 1-3 and described above. The inner ring is a generally solid element formed of a generally rigid material. However, the inner ring comprises one or more slits to facilitate expansion and contraction of the ring in response to radial forces. The slits may be through the entire thickness and length of the sleeve or the slits may be partial slits, meaning they extend through part of the length and/or thickness of the ring. Additionally, the outer ring 740 is configured substantially similar to the outer ring 140 illustrated in FIG. 4 and described above. For instance, the outer ring 740 includes a tapered bore and has an alignment element, such as a flange 746 extending around the bore of the outer sleeve. A circumferential flange 744 also projects axially around the periphery of the outer sleeve to form a contact surface for engaging the sidewall of the machine element to be mounted.

The thrust plate 730 comprises a solid ring having an internal bore 739 similar to the outer diameter of the rotatable element onto which the device 710 is to be mounted. For instance, the internal bore matches the outer diameter of a shaft. The thrust plate 730 also includes an inner face for engaging the side of a rotatable element, such as a machine element to transfer axial clamping force to the machine element to couple the machine element with the mounting device 710. The inner face of the thrust plate 730 may substantially planar. However, in the present instance, the thrust plate comprises a circumferential flange 734 that projects axially to form a contact surface for engaging the side of the machine element. Additionally, as shown in FIG. 14, the inner face of thrust plate forms a recess or relieved area 735 to provide a gap between the thrust plate and side of the machine element along the face of the thrust plate except for at the circumferential flange 734.

Operation of the device 710 is similar to the operation of the mounting device illustrated in FIGS. 1-4 and described above. Specifically, the bore of a rotating element, such as a machine element, is aligned onto the alignment flange 746 of the outer sleeve and the assembly is placed onto a second rotatable element, such as a shaft so that the shaft passes through the bore of the inner sleeve 720 and the thrust plate 730. The device 710 is tightened by incrementally tightening each lock screw 750 which draws the inner sleeve 720 toward the thrust plate 730, which in turn draws the major diameter of the tapered surface of the inner sleeve toward the minor diameter of the tapered surface of the outer sleeve 740. In this way, the mounting device generates radially clamping forces that contract the inner ring 720 inwardly to engage the shaft and the device generates axial forces that clamp the sides of the machine element between the contact surfaces formed by the circumferential flanges 734, 744. Compared to the embodiment shown in FIGS. 1-4, the embodiment in FIG. 12 can accommodate machine elements of substantially different lengths by changing only the length of the locking screws rather than changing the length of either of the sleeves.

The device 710 is loosened by incrementally loosening each lock screw 750 which removes the axial force between the clamping surfaces 734, 744 and the machine element. As the axial force is removed, the tapers disengage which removes the radially clamping forces that contract the inner ring 720 inwardly to engage the shaft. The inner ring is sufficiently elastic that it returns to its pre-tightened shape when the radial forces are removed. In this way, the sliding clearance between the shaft and the inner ring is returned.

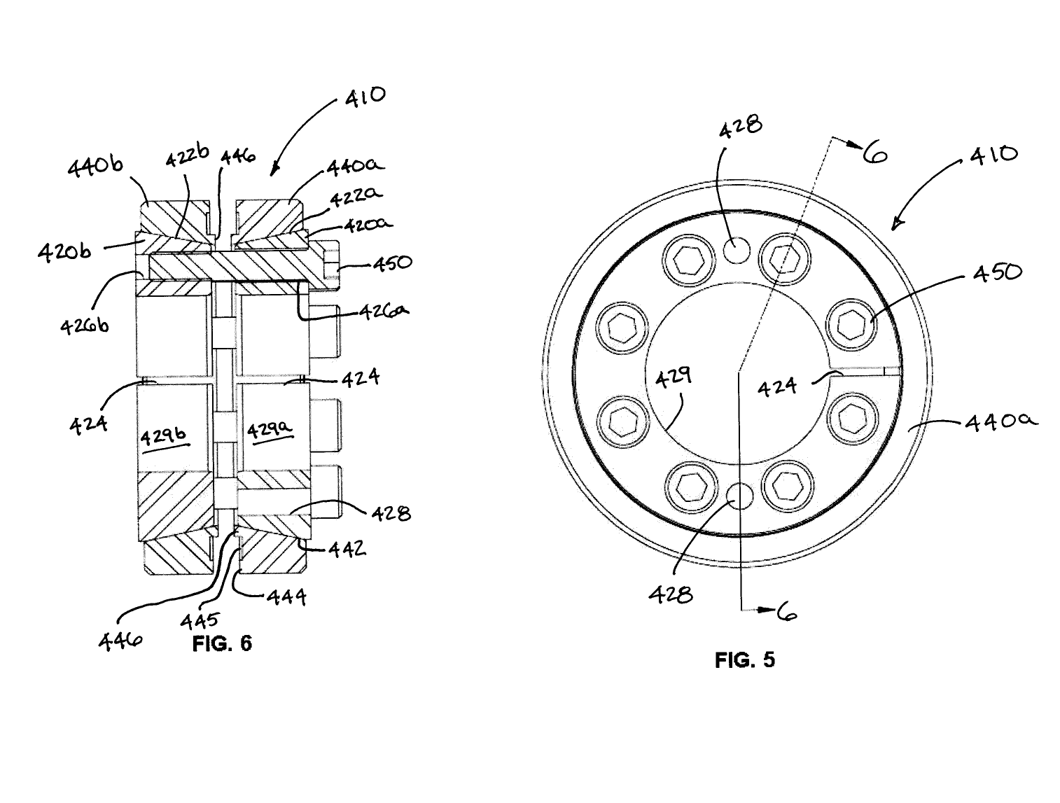

Referring now to FIGS. 5-7 a device for coupling two rotatable elements is designated generally 410. The embodiment in FIGS. 5-7 is similar to the embodiment illustrated in FIG. 12 and described above, except that the device 410 replaces the thrust plate 730 with a second pair of inner and outer rings. In particular, the device 410 includes two pairs of nesting inner and outer rings that oppose one another. The locking screws extend between the opposing pairs of inner and outer rings and operate to tighten and release the inner and outer rings. The components of the mounting device may be formed of any of a variety of materials that are generally rigid, however, in the present instance the components are formed of metal, such as steel.

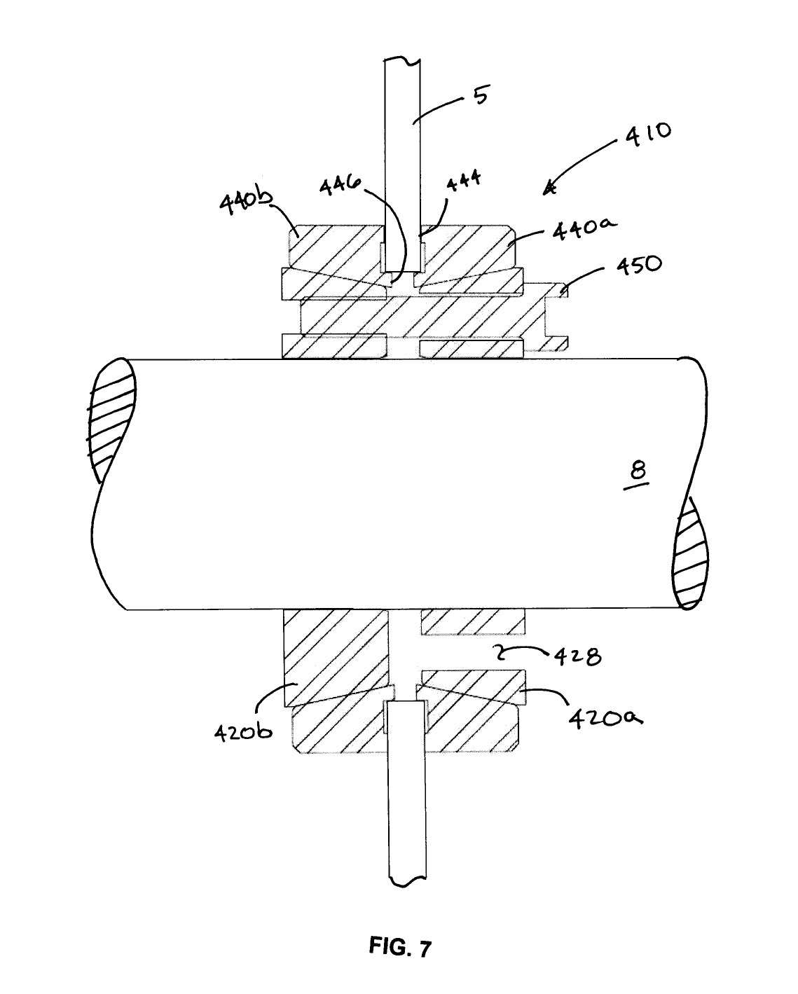

Referring to FIGS. 6-7, the device 410 includes a forward inner ring 420a having an internal bore 429a configured to mate with the external surface of a rotatable element, such as a cylindrical shaft. The inner ring is a generally solid element formed of a generally rigid material. However, the inner ring comprises a slit 424 to facilitate expansion and contraction of the ring in response to radial forces. The slit may be through the entire thickness and length of the sleeve or the slit may be a partial slit, meaning it extends through part of the length and/or thickness of the ring.

The circumferential surface or outer radial surface of the forward inner ring 420a comprises a tapered surface 422a. In the present instance, the ring forms a frustoconical outer surface. The taper of the circumferential surface is configured to mate with the inner surface of the forward outer ring 440a. Specifically, the forward outer ring 440a is a solid ring having a tapered bore 442. As shown in FIGS. 6-7, the tapered bore 442 mates with the tapered circumference 422a of the inner ring 420a. In this way, the cooperating tapered surfaces are operable to produce a wedging force that creates a radial clamping force when the outer ring is displaced relative to the inner ring.

As described above, the outer ring 440a is substantially solid and rigid so that the outer ring substantially impedes radial expansion/contraction of the outer ring in response to radial forces created when the device is tightened. The outer ring 440a further comprises a radial alignment element 446 for radially aligning the machine element 5 relative to the shaft 8. In particular, the radial alignment element is a flange projecting axially away from the inner face of the inner sleeve as shown in FIG. 6. The flange 446 creates a cylindrical shoulder that mates with the internal bore of the machine element to align the machine element with the shaft.

Additionally, the outer ring 440 may also comprise a circumferential flange 444 projecting axially around the outer periphery of the outer ring 440 as shown in FIG. 6. In this way, a recess or relieved area 445 is formed on the inner face of the outer sleeve between the circumferential flange 444 and the alignment flange 446. Therefore, the contact area between the outer ring 440 and the machine element 5 is spaced away from the axis of rotation to the outer radial extent of the outer sleeve, thereby increasing the length of the lever arm to increase the torque that can be supported by the axial coupling between the outer ring and the machine element.

As shown in FIG. 6, the rearward outer ring 440b is substantially a mirror of the forward outer ring 440a so that the alignment flanged 446 of the opposing rings are radially aligned to support and align the bore of the machine element. Additionally, the circumferential flanges 444 of the opposing rings 440a,b oppose one another to form clamping surfaces to apply opposing axial clamping forces on the sides of the machine element.

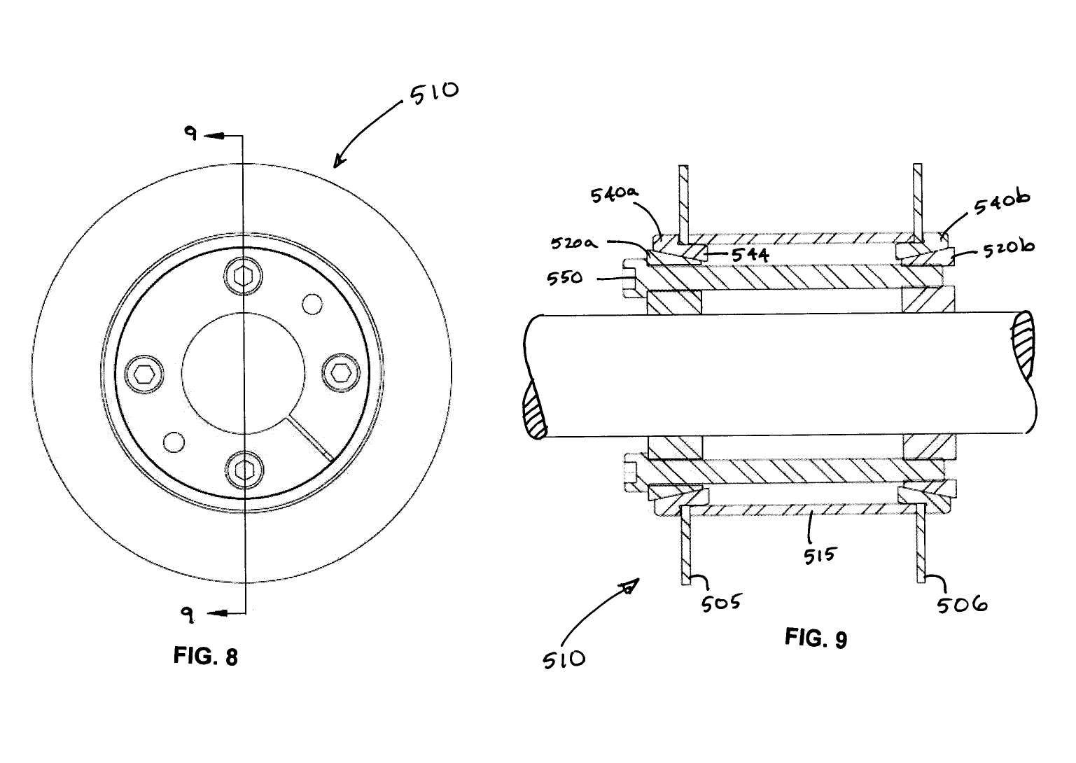

The rearward inner ring 420b is also substantially a mirror of the forward inner ring 420a, except for the bolt holes in the forward and rearward inner rings. For instance, in the present instance, the inner rings 420a, b have a plurality of bolt holes spaced around the diameter of the rings as shown in FIGS. 7-8. A first set of bolt holes 426a are used for tightening the device. The bolt holes 426a through the forward inner ring 420a are cylindrical holes that are aligned with threaded bolt holes 426b in the rearward inner ring. In this way, the bolt holes in the forward inner ring are not threaded and have a larger diameter than the major diameter of the tightening bolts 450, so that the tightening bolts pass through the forward inner ring and threadedly engage the bolt holes 426b in the rearward inner ring 420b. In this way, rotating the tightening bolts in a first direction draws the rearward inner ring toward the forward inner ring, thereby displacing the forward inner ring axially relative to the rearward inner ring.

One or both of the inner rings 420a,b may also include a set of bolt holes for loosening the device. Specifically, loosening the tightening bolts 450 from the tightening bolt holes may not release the engagement between the tapered surfaces of the inner and outer rings. Specifically, releasing the tightening bolts 450 does not positively drive the inner rings relative to the outer rings to release the wedging effect of the tapered surfaces. Therefore, as shown in FIGS. 7-8, one of the inner rings 420a,b may include one or more loosening bolt holes 428.

In the present instance, the forward inner ring 420 includes a plurality of loosening bolt holes 428 equally spaced apart around the inner ring. Specifically, the forward inner ring 420a comprises two threaded holes spaced apart approximately 180° from one another. The holes 428 may be threaded similar to the thread size and pitch of the tightening bolt holes 426b in the rearward inner ring 420b.

Configured as described above, the mounting device 410 operates as follows. As shown in FIG. 7, a machine element 5 is placed between the pairs of inner and outer rings 420a, 440a and 420b, 440b so that the bore 6 of the machine element mates with the alignment elements 446 of the outer rings. The tightening bolts 450 are inserted through the bolt holes 426 in the forward inner ring 420a so that the bolts extend through the bore of the machine element and are threaded into the threaded bolt holes 426b in the rearward inner rings. The tightening bolts 450 may be screwed into the rearward inner rings until the assembly is snug, but not tight, meaning that the mounting device and machine element are tight enough that the various parts do not freely move relative to one another, but not so tight that the cooperating tapers of the inner and outer rings begin to deflect the inner ring radially inwardly.

Once the assembly is snug, the assembly may be inserted onto a rotating element, such as a shaft 8. The assembly may then be moved along the shaft to the proper axial and radial position. After the assembly is properly positioned along the shaft the assembly is tightened by rotating the locking bolts 450. In the present instance, the locking bolts 450 are tightened gradually. Specifically, one locking bolt is tightened a certain amount and then each of the remaining locking bolts are tightened a similar amount. This process continues by incrementally tightening each bolt until the mounting device is tightened sufficiently to provide the desired amount of contact pressure with the machine element and shaft.

As the locking bolts 450 are tightened, the rearward inner ring 420b is drawn toward the forward inner ring 420a. As the rearward inner ring is displaced relative to the forward inner ring, the cooperating tapered surfaces 422a, 422b, 442a, 442b provide a wedging force that creates a radial clamping force. Since the outer rings 440a, b are substantially radially rigid, the radial clamping force deflects the inner rings 420a, 420b inwardly to clamp onto the shaft 8. More specifically, as shown in FIGS. 5-6, the tapered surfaces of the inner rings 420a,b are oriented so that the major diameter of the tapered surfaces is disposed adjacent the outer faces of the rings. In this way, tightening the locking bolts 450 pulls the inner rings 420a,b toward one another, which in turn pulls the major diameter of the inner rings 420a,b toward the minor diameter of the outer rings 440a, b, thus creating the radially directed clamping force compressing the inner sleeves inwardly toward the shaft. At the same time, tightening the locking bolts pulls the inner rings toward one another, which in turn creates an axial force component. Specifically, the axial clamping component is directed through the outer rings 440a, b to clamp onto the sides of the machine element. In particular, the inner faces of the outer rings 440a, b engage the faces of the machine element to clamp or squeeze the machine element between the outer rings. As discussed above, the outer rings comprise circumferential flanges 444 and a relieved portion 445 so that the contact area in which the axial clamping forces are applied to the machine element are radially spaced from the axis of rotation. In particular, the contact area may be radial spaced from the axis of rotation a distance greater than the width of the machine element. Specifically, the contact area may be radially spaced from the axis at least 5-10 times the width of the machine element and it may be spaced from the axis of rotation 10-20 times the width of the machine element or more.

As described above, the outer rings 440a, b are substantially rigid so that they do not substantially deform in response to the radial force generated during the tightening process. However, it should be understood that the configuration of the outer rings and/or the material from which they are formed may provide sufficient elasticity such even though the rings do not substantially deform, the outer rings may nonetheless deform or deflect a small amount. For instance, as described above, the inner bore 6 of the machine element 5 is configured to fit onto the alignment element 446. In order for the machine element to fit onto the alignment element there is likely to be a small amount of clearance or space between the bore of the machine element and the outer surface of the alignment element 446. Specifically, in the present instance, the bore of the machine element has a diameter that is a few thousandths of an inch larger than the outer diameter of the alignment element 446. The outer rings 440a, b have sufficient elasticity such that the radial force generated by the wedging tapered surfaces causes a minor radial expansion of the outer rings 440a, b to reduce or eliminate the clearance gap between the machine element bore and the alignment element. By reducing the clearance between the bore of the machine element 5 and the centering flange 446, this expansion acts to improve the centering of the machine element 5 on the shaft 8.

To loosen the device, the locking screws 450 are rotated in a second direction to withdraw the locking screws from the threaded bolt holes 426b in the rearward inner ring 420b. However, unscrewing the locking bolts 450 may not release the wedged tapered surfaces of the inner and outer rings. Accordingly, to loosen the device, after the locking bolts are unscrewed, a bolt, such as one of the locking bolts is threaded into one of the loosening holes 428. The bolt is rotated into the loosening hole until the tip of the bolt engages the forward face of the rearward inner ring 420b. As shown in FIGS. 6-7, the surface of the rearward inner ring opposing the loosening holes 428 is solid. Therefore, once the loosening bolt engages the face of the rearward inner ring, continued rotation of the loosening bolt drives the inner rings away from one another. In turn, the opposing axial clamping forces on the machine element 5 and outer rings 440a, b are relaxed and the wedged surfaces can self-relax.

Because the device 410 includes two pairs of opposingly tapered sleeves, the net axial forces between the inner sleeves 420a, 420b and the shaft generated during tightening are minimized or eliminated, thereby substantially limiting or eliminating axial displacement of the device 410 on the shaft during tightening. In particular, when the device is tightened, the cooperating tapered surfaces of the inner and outer sleeves 420a, 440a may create an axial force that would tend to displace the device along the shaft. However, the second pair of inner and outer sleeves 420b, 440b are configured with tapers similar to the tapers of sleeves 420a, 440a but in the opposite direction. Therefore, axial forces generated by inner and outer sleeves 420a, 440a during tightening would be substantially balanced by equal and opposite axial forces generated by inner and outer sleeves 420b, 440b. Therefore, the net axial force between the device and the shaft generated during tightening is not sufficient to displace the device along the shaft. Such a design is referred to as a non-traversing design.

Referring now to FIGS. 8-9 a variation of the embodiment shown in FIGS. 5-7 is designated 510. The mounting device 510 is particularly suited to mount a series of machine elements onto a shaft along the length of the shaft. As can be seen in FIG. 8, the mounting device has many elements configured substantially similarly to the embodiments illustrated in FIGS. 5-7 and described above. For instance, the device includes opposing pairs of inner and outer rings 520a, 540a and 520b, 540b having cooperating tapered surfaces. However, in the present instance, the flange 544 forming the alignment element projects further axially on the present device 510 than on the device illustrated in FIGS. 5-7. In particular, the flange projects axially further than the distance between the flange and the outer periphery of the outer ring. In this way, the alignment flange forms a bearing surface for mating with the bore of the machine elements 505, 506 and the bore of a spacer sleeve 515 as discussed further below.

As shown in FIG. 9, the mounting device 510 is operable to mount a plurality of machine elements between the opposing pairs of inner and outer rings. In this way, it should also be seen that differing axial lengths of machine elements are accommodated by changing only the length of the locking screws. The device includes a spacing element that fills the gap between the two machine elements so that when axial clamping force is applied to one of the machine elements, the axial clamping force is applied to both machine elements. The spacer 515 may be formed in any of a variety of configurations, however, in the present instance, the spacer is a hollow cylindrical sleeve having an interior surface formed to mate with the alignment flanges 546 on the outer rings 540. In particular, the spacer 515 is formed of metal, such as steel and has sufficient axial rigidity to transfer the axial clamping forces without significant axial deformation. It should also be understood that the spacer may be segmented or formed into a plurality of spacers so that more than two machine elements can be mounted onto the mounting element with spacers spanning the space between adjacent machine elements to radially and axially locate the machine elements and transmit the axial clamping force.

Referring to FIG. 8, the mounting device 510 has a different locking bolt pattern than the mounting device 410 described above. In particular, the mounting device 510 includes only 4 locking bolts equally spaced around the locking device. In this way, it should be seen that the number and spacing of tightening bolts may be varied depending upon the application and the desired clamping forces to be generated.

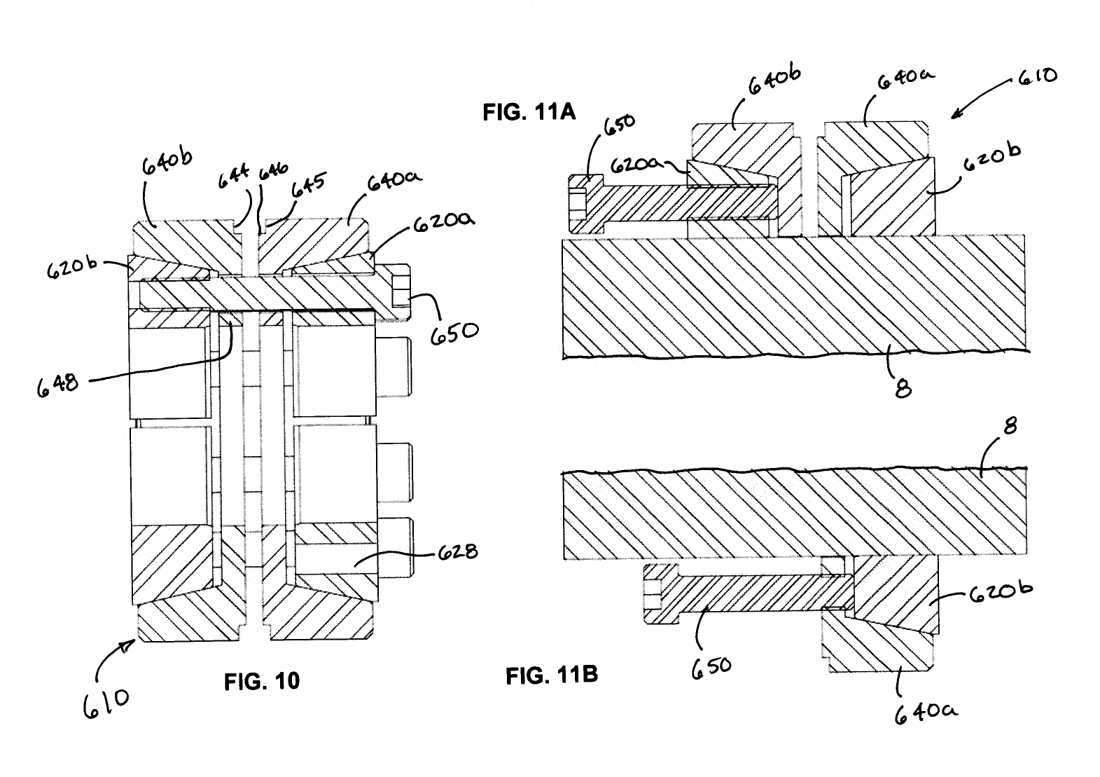

Referring now to FIGS. 10-11A&B, a variation of the mounting devices illustrated in FIGS. 5-9 is designated 610. The mounting device 610 comprises opposing pair of inner and outer rings 620a, 640a and 620b, 640b that having cooperating tapered surfaces that create radial clamping forces and axial clamping forces when locking bolts 650 are tightened, similar to the embodiments described above.

As shown in FIG. 10, the outer rings 640a, b comprise a circumferential groove 644 adjacent the outer periphery. The circumferential groove 644 forms a vertical surface 645 and a horizontal surface 646. The vertical surface 645 forms the contact surface for transmitting the axial clamping forces to the machine element and the horizontal surface forms the alignment surface for aligning the bore of the machine element perpendicular to the axis of rotation. In this way, the alignment element and the contact surface are moved to the periphery of the mounting device 610.

The outer rings 640a, b further comprise radial extensions 648 that project radially inwardly. Additionally, the radial extensions 648 comprise bolt holes aligned with the bolt holes in the inner rings so that the locking bolts 650 pass through the bolt holes in the radial extensions and into the threaded bolt holes in the rearward inner ring 620b. However, as shown in FIG. 13A, the loosening holes 628 in the forward inner ring do not align with bolt holes in the radial extension. In this way, to release the engagement between the tapered surfaces of the outer rings and the inner rings, first a bolt is threaded into one of the loosening bolt holes 628a in the inner ring until it abuts the radial extension 648. Continuing to thread the bolt into the unlocking bolt hole with operate to drive the inner ring out of the outer ring to release the wedged tapers. After the first outer ring and inner ring are released, the two rings can be removed from the assembly, which will provide access to threaded bolt holes in the remaining outer ring. Threading the bolt into the bolt hole in the radial extension 648 of the remaining outer ring drives the inner ring out of the outer ring, thereby releasing the tapered surfaces as shown in FIG. 11B.

Referring now to FIG. 13, yet another embodiment of a mounting device is illustrated and is designated 810. The components of mounting device 810 are substantially similar to the components of mounting device 710 illustrated in FIG. 12 and described above. In particular, the mounting device comprises inner and outer rings 820, 840 having cooperating tapers and an opposing clamping plate 830.

As shown in FIG. 13, the clamping plate 830 is configured similar to the clamping plate 730 in FIG. 12 except the clamping plate 830 includes an axially extending protrusion 832 adjacent the central bore 839 of the clamping plate. The axial protrusion 832 forms a collar having a bore configured to mate with the shaft. The clamping plate 830 further includes a circumferential flange 834 forming a contact surface and a recess 835 similar to the flange 734 and recess 735 of the previously described embodiment 710. The inner ring 820 is similar to the inner ring 720 described above except that the inner ring 820 has a bore configured to mate with external cylindrical surface of the axial protrusion 832. In this way, the inner ring overlies the axial protrusion 832 of the clamping plate. The outer ring 840 is substantially similar to the outer 740 described above. Specifically, the outer ring has a tapered internal bore that cooperates with the tapered outer surface of the inner ring 820, as well as an alignment flange 846 and a flange 844 forming a contact surface.

Operation of the device 810 differs from the operation of the mounting device illustrated in FIG. 12 above. Specifically, the bore of a machine element, is aligned onto the alignment flange 846 of the outer sleeve and the assembly is placed onto a shaft so that the shaft passes through the bore of the axial protrusion 832 of the thrust plate 830. The device 810 is tightened by incrementally tightening each lock screw 850 which draws the inner sleeve 820 toward the thrust plate 830, which in turn draws the major diameter of the tapered surface of the inner sleeve toward the minor diameter of the tapered surface of the outer sleeve 840. In this way, the mounting device generates radially clamping forces that contract the inner ring 820 inwardly to engage the outer surface of the axial protrusion 832 of the thrust plate which is radially deformed into clamping engagement with the shaft. At the same time, the device generates axial forces that clamp the sides of the machine element between the contact surfaces formed by the circumferential flanges 834, 844. Compared to the embodiments shown in FIGS. 5-12, the embodiment in FIG. 13 can accommodate machine elements of slightly different lengths by changing only the length of the locking screws. In order to accommodate machine elements of largely different lengths, the axial protrusion 832 can be made longer when the inner sleeve is formed..

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A mounting device for coupling a first rotatable element having an external surface and a second rotatable element having an internal bore and first and second sides, wherein the device comprises:
a hollow inner sleeve having an internal bore to cooperate with the external surface of the first rotatable element, comprising:
a threaded portion;
a tapered surface; and
at least one axial slot extending along a portion of the inner sleeve adjacent the tapered surface to permit radial expansion and contraction of the inner sleeve;
an outer sleeve comprising:
an internal bore having a tapered surface engaging the tapered surface of the inner sleeve;
a side wall transverse the internal bore, wherein the side wall has an engagement surface for engaging the first side of the second rotatable element;
wherein the outer sleeve is substantially rigid radially such that the outer sleeve resists radial expansion or contraction in response to a radial load;
a clamping plate having a bore to fit over the external surface of the first rotatable element, wherein the clamping plate has a side surface for engaging the second side of the second rotatable element; and
a locking element having a threaded portion for threadedly engaging the threaded portion of the inner sleeve;
wherein rotating the locking element in a first direction displaces the clamping plate axially relative to the inner sleeve so that the side surface of the clamping plate and engagement surface of the outer sleeve clamp onto the first and second sides of the second rotatable element and rotating the locking element in the first direction also displaces the tapered surface of the inner sleeve relative to the internal tapered surface of the outer sleeve creating a radially directed clamp force that deforms the inner sleeve radially inwardly to clamp onto the external surface of the first rotatable element.

2. The device of claim 1 wherein the locking element is a lock nut having an internally threaded portion and the inner sleeve has a cooperating externally threaded portion.

3. The device of claim 1 wherein the locking element is a lock screw having an externally threaded portion and the inner sleeve has a cooperating internally threaded portion.

4. The device of claim 1 comprising an alignment element engaging the internal bore of the second rotatable element to align the second rotatable element relative to the first rotatable element.

5. The device of claim 4 wherein the alignment element maintains the second rotatable element perpendicular to the axis of rotation of the first rotatable element.

6. The device of claim 4 wherein the alignment element comprises a curved flange projecting around the bore of the outer sleeve, wherein the flange projects axially away from the side of the outer sleeve.

7. The device of claim 1 wherein the clamping plate is axially deformable.

8. The device of claim 7 wherein the clamping plate exerts an axial bias force between the locking element and the inner sleeve.

9. The device of claim 7 wherein the clamping plate comprises a Belleville washer.

10. A mounting device for coupling a shaft having an external surface and a machine element having an internal bore and first and second sides, wherein the device comprises:
a hollow inner sleeve having an internal bore to overlie the external surface of the shaft, comprising:
an internally threaded socket;
a tapered surface; and
at least one axial slot to permit radial expansion and contraction of the inner sleeve;
an outer sleeve comprising:
an internal bore having a tapered surface engaging the tapered surface of the inner sleeve;
a side wall transverse the internal bore, wherein the side wall has an engagement surface for engaging the first side of the machine element;
wherein the outer sleeve is substantially rigid radially such that the outer sleeve resists radial expansion or contraction in response to a radial load;
a clamping plate having a bore to fit over the external surface of the shaft, wherein the clamping plate has a side surface for engaging the second side of the machine element; and
a locking element having a threaded portion for threadedly engaging the threaded socket of the inner sleeve;
wherein rotating the locking element in a first direction to tighten the device displaces the clamping plate axially relative to the outer sleeve so that the side surface of the clamping plate and engagement surface of the outer sleeve clamp onto the first and second sides of the machine element and rotating the locking element in the first direction also displaces the tapered surface of the inner sleeve relative to the internal tapered surface of the outer sleeve creating a radially directed clamp force that deforms the inner sleeve radially inwardly to clamp the device onto the external surface of the shaft.

11. The device of claim 10 wherein an alignment element aligns the machine element perpendicular to the axis of rotation of the shaft.

12. The device of claim 10 wherein the alignment element comprises a curved flange projecting around the bore of the outer sleeve, wherein the flange projects axially away from the side of the outer sleeve.

13. The device of claim 10 wherein the alignment element comprises a plurality of contact surfaces protruding from the side of the outer ring having a diameter and the difference between the diameter of the contact surfaces and the internal bore of the machine element is a clearance tolerance to allow the machine element to mount onto the alignment element.

14. The device of claim 10 wherein upon tightening the device, the radially directed clamping force causes the alignment element to be displaced radially outwardly to reduce or eliminate the clearance tolerance between the machine element and the alignment element.

15. The device of claim 10 wherein upon tightening the device the clamping force deforms the outer sleeve to reduce the clearance tolerance between the machine element and the alignment element.

16. The device of claim 10 wherein the inner sleeve comprises a plurality of threaded sockets spaced apart around the inner sleeve and the device comprises a plurality of locking elements spaced about the circumference of the clamping plate to threadedly engage the threaded sockets, wherein the device is tightened by rotating the plurality of locking elements.

17. The device of claim 10 wherein the clamping plate opposes the inner and outer sleeves and the clamping plate comprises:
a second inner sleeve having an internal bore to cooperate with the external surface of the shaft, comprising:
a tapered surface; and
at least one axial slot to permit radial expansion and contraction of the inner sleeve;
a second outer sleeve comprising:
an internal bore having a tapered surface engaging the tapered surface of the second inner sleeve;
a side wall transverse the internal bore, wherein the side wall has an engagement surface for engaging the second side of the machine element;
wherein rotating the locking element in a first direction to tighten the device displaces the second inner sleeve relative to the second outer sleeve so that the engagement surface of the second outer sleeve clamps onto the second side of the machine element and rotating the locking element in the first direction also displaces the tapered surface of the second inner sleeve relative to the internal tapered surface of the second outer sleeve creating a radially directed clamp force that deforms the second inner sleeve radially inwardly to clamp the device onto the external surface of the shaft.

18. The device of claim 17 wherein the second inner sleeve comprises a second alignment element engaging the internal bore of the machine element to align the machine element relative to the shaft.

19. The device of claim 10 wherein the clamping plate comprises a cylindrical band overlying the shaft and wherein the inner sleeve overlies the cylindrical band.

20. A mounting device for coupling a shaft having an external surface and a machine element having an internal bore and first and second sides, wherein the device comprises:
a clamping plate having a bore to fit over the external surface of the shaft, wherein the clamping plate has a side surface for engaging the first side of the machine element; and
an axial protrusion having at least one axial slot to permit radial expansion and contraction of the protrusion
a hollow inner sleeve having an internal bore to overlie the external surface of the axial protrusion of the clamping plate, comprising:
an internally threaded socket;
a tapered surface; and
at least one axial slot to permit radial expansion and contraction of the inner sleeve;
an outer sleeve comprising:
an internal bore having a tapered surface engaging the tapered surface of the inner sleeve;
a side wall transverse the internal bore, wherein the side wall has an engagement surface for engaging the first side of the machine element;
an alignment element engaging the internal bore of the machine element to align the machine element relative to the shaft;
wherein the outer sleeve is substantially rigid radially such that the outer sleeve resists radial expansion or contraction in response to a radial load;
a locking element having a threaded portion for threadedly engaging the threaded socket of the inner sleeve;
wherein rotating the locking element in a first direction to tighten the device displaces the inner sleeve axially relative to the clamping plate so that the tapered surface of the inner sleeve engages the tapered surface of the outer sleeve so that the side surface of the clamping plate and engagement surface of the outer sleeve clamp axially onto the first and second sides of the machine element and the wedging tapers create a radially directed clamp force between the inner surface of the inner sleeve and the outer surface of the axial protrusion of the clamping plate which deforms the axial protrusion of the clamping plate to clamp the device onto the external surface of the shaft.

21. The device of claim 1 wherein the machine element comprises a plurality of rotatable machine elements and a cylindrical spacer extending between the rotatable machine elements, wherein the cylindrical spacer comprises a bore that cooperates with the alignment element.
